(19) United States
(12) Patent Application Publication
(10) Pub. No.: US 2016/0119981 A1
(43) Pub. Date: Apr. 28, 2016

(54) HEATER APPARATUS AND CONTROLLABLE HEATING PROCESS

(71) Applicant: COREBON AB, Arlöv (SE)

(72) Inventors: Kenneth FROGNER, Arlöv (SE); Mats ANDERSSON, Arlöv (SE); Tord CEDELL, Arlöv (SE)

(21) Appl. No.: 14/894,982

(22) PCT Filed: May 30, 2014
(86) PCT No.: PCT/EP2014/061283

§ 371 Date: Nov. 30, 2015

(30) Foreign Application Priority Data
May 30, 2013 (SE) 1300396-7

(51) Int. Cl. H05B 6/14

(52) U.S. Cl. CPC H05B 6/14; H05B 2206/024

(57) ABSTRACT

An apparatus for controllable heating is provided comprising at least one coil system (110) with at least one coil unit (111) connected to a power source, where the coil unit (111) is arranged to create a magnetic field. The apparatus further comprises at least one electric current conductor (120) which is arranged at least partly around said coil unit (111), and at least one element (130) which is configured to be heated and which is connected to the electric current conductor (120) in such a way that the electric current conductor (120) and the element (130) form a closed conduit. The magnetic field of the coil unit (111) is arranged to induce a voltage in the electric current conductor (120) and the element (130), where the induced voltage creates an electric current in the closed conduit, and where the element (130) is configured to be heated by the electric current.

### TECHNICAL FIELD

The present invention relates to uniform and/or controlled heating process of a workpieces, tools or surfaces.

### BACKGROUND

Today there are two alternative techniques in order to achieve a rapid heating of a tool surface, inductive heating and resistive heating. Both these methods are based on only to heat the outermost layer of the tool which then consists of a suitable metal or composite. The rest of the tool, if supporting structures are necessary, may consist of another material. The rapidity of the heating is achieved by substantially reducing the heated volume of the tool. In order for the technique to be industrially usable it is however required that the heating is conducted with an even or controlled temperature of the entire surface, which today, with known technique, is not possible.

### INDUCTION HEATING IN GENERAL

Induction heating is characterized by that energy is transmitted without any contact to the workpiece by means of a high frequency electrical current driven by a coil which in turn gives rise to a magnetic field which induces currents in the workpiece. The coil is often surrounded by some type of soft magnetic core, e.g. iron powder composite (SMC) or ferrites, in order to increase the efficiency and focus the effect where the heating is desired. The result is a system where rapid and efficient heating may be accomplished, but which could involve great difficulties to heat evenly over larger areas. There are a number of solutions to even out the heating profile all with its own disadvantages and limitations, e.g. to heat thick workpieces in such a way that the heat conduction in the material becomes significant, to continuously move the workpiece with respect to the heating coil, or to use coils with a very low efficiency and have strict requirements on the distance between the coil and the workpiece. Typical heating patterns which may be achieved by traditional induction heating are shown in FIGS. 15a-15c

Resistive Heating in General

Resistive heating works in a way that a large current is driven through the workpiece which becomes hot, in the same way as a filament in a filament lamp. Depending on the choices of material and geometry it takes very large currents which can lead to problems with electrical contacts where local overheating easily can occur. In order to achieve a uniform heating it requires both good electrical contact along two edges or lines and constant area for the current along the entire distance between the two connection lines, see FIG. 5a. The method has a good controllability seen from a perspective of maximum temperature or total effect, but lacks geometrical control of the effect and may therefor not compensate for geometrical load variations, e.g. in the contact edges. It is also not possible to locally provide more effect if the process requires it. Depending on the frequency of the current the operation area and the uniformity of the temperature affected, high frequency provides undesired edges or corner effects, FIG. 15b, (uneven heat) while low frequency feeds the heat in the entire workpiece and not just on the surfaces which requires significantly higher current and lower voltage. FIGS. 5a and 5b illustrate a problem which occurs if the cross section of the tool is not constant. The heated volume may e.g. be a sheet where a current is transferred between two electric poles (connection lines) along an upper and a lower edge. Where ever the volume of the tool is the smallest the temperature will be the highest. This problem also occurs when heating double curved surfaces.

There are known and established techniques to evenly heat pipes or cylindrical objects with surrounding coils, see for example U.S. Pat. No. 5,059,762. This document discloses a number of parallel and cylindrical coils which are arranged and driven in such a way that even and controllable heating may be achieved. Its disadvantages are however that the heated object must have a closed shape, i.e. a rod, pipe or profile. To heat a non-closed shape such as a flat or curved surface, or precision heating only one part of a workpiece is not possible with this technique since all currents have to start and end up in the same point. Its surrounding coils also have to be arranged in direct connection with the workpiece in order to work satisfying.

Conventional technique is based on heating large tool quantities (with hot oil, immersion heaters, etc.) where a heat conduction has to occur before an even temperature can be achieved which requires a lot of time and energy and is therefor expensive.

### SUMMARY

The development of the present invention corresponds to a general need of rapid, efficient, and controlled heating of e.g. surfaces for industrial applications. An example of a surface may be a tool surface for pressing polymer materials where there is a need for an even heating over the entire surface and also the possibility to rapid heating and cooling. An object of the present invention is to provide improvements over prior art. This object is achieved by a technique defined in the appended independent claims; certain embodiments being set forth in the related dependent claims.

In a first aspect of the present invention there is provided an apparatus for controllable heating, comprising at least one coil system with at least one coil unit connected to a power source, where the coil unit is arranged to create a magnetic field. The apparatus further comprises at least one electric current conductor which is arranged at least partly around said coil unit, and at least one element which is configured to be heated and which is connected to the electric current conductor in such a way that the electric current conductor and the element form a closed conduit. The magnetic field of the coil unit is arranged to induce a voltage in the electric current conductor and the element, where the induced voltage creates an electric current in the closed conduit, and where the element is configured to be heated by the electric current. The above described apparatus creates a controllable and uniform heating process for plane surfaces, curved and double curved surfaces, bodies of any kind or any other object with a simple or complex shape and size. This configuration allows for a fast and precise geometrically controllable heating of the element over the entire area of interest.

In an embodiment of the invention the element is a detachable element configured to be removed from the apparatus after a heating process. The element can then represent the workpiece in a process and the arrangement thus allows for very fast and controllable heating of components in production. The setup also features high versatility and a single tool can be used for heating components with different geometries.

In another embodiment the element is a tool element, configured to heat an adjacent workpiece during a heating process. The invention can save large amounts of energy and speed up the productivity significantly compared to alternative solutions. A controllable heating pattern also ensured a high quality of the produced items.

Objects and advantages of the present invention will be clear to a person skilled in the art when reading the detailed description and viewing the drawings. The concept of the invention is defined in the independent claims while certain embodiments of the invention are defined in the dependent claims.

### BRIEF DESCRIPTION OF THE DRAWINGS

Embodiments of the invention will be described in the following, reference being made to the appended drawings which illustrate non-limiting examples of how the inventive concept can be reduced into practice.

FIG. 1a is a cross section view of a heating apparatus according to a first embodiment of the present invention,

FIG. 1b is a cross section of an alternative embodiment of the heating apparatus in FIG. 1a,

FIG. 2a is a cross section view of a heating apparatus according to a second embodiment of the present invention,

FIG. 2b is a perspective view of the heating apparatus in FIG. 2a

FIGS. 3a and 3b are perspective views of two alternatives of a heating apparatus according to a third embodiment of the present invention,

FIG. 3c is a cross section view of the heating apparatus in FIGS. 3a and 3b

FIG. 4a is a perspective view of a heating apparatus according to a fourth embodiment of the present invention,

FIG. 4b is a partial cross section view of the heating apparatus in FIG. 4a,

FIG. 5a shows a tool section used during resistive heating,

FIG. 5b shows a heating result of a resistive heating process,

FIG. 6a is a perspective view of a heating apparatus according to a fifth embodiment of the present invention,

FIG. 6b is a cross section view of the heating apparatus in FIG. 6a,

FIG. 7a is a cross section front view of a heating apparatus according to a sixth embodiment of the present invention,

FIG. 7b is a top view of the heating apparatus in FIG. 7a,

FIG. 8a is a perspective view of a heating apparatus according to a seventh embodiment of the present invention,

FIGS. 8b-8d are cross section views of the heating element in FIG. 8a,

FIG. 9a is a perspective view of a heating apparatus according to an eighth embodiment of the present invention,

FIG. 9b is a top view of the heating apparatus in FIG. 9a,

FIG. 9c is a front view of the heating apparatus in FIG. 9a,

FIG. 9d is a side view of the heating apparatus in FIG. 9c,

FIGS. 10a-d shows typical heating patterns achieved by the present invention,

FIGS. 11a-11e show a disassembly process of a heating apparatus according to a ninth embodiment of the present invention

FIGS. 12a and 12b are cross section views of a heating apparatus according to a tenth embodiment of the present invention,

FIGS. 13a and 13b are cross section views of a heating apparatus according to an eleventh embodiment of the present invention,

FIG. 13c is a top view of the heating apparatus in FIGS. 13a and 13b,

FIG. 13d is a perspective view of the heating apparatus in FIGS. 13a and 13b,

FIGS. 14a-c are cross section views of a heating apparatus of a twelfth embodiment of the present invention,

FIGS. 15a-c are possible heating patterns achieved by existing heating methods, and

FIG. 15d is a uniform heating pattern that can be obtained by combining the result of FIG. 15b and FIG. 15c, which can be obtained by the heating apparatus according to the present invention.

### DETAILED DESCRIPTION OF EMBODIMENTS

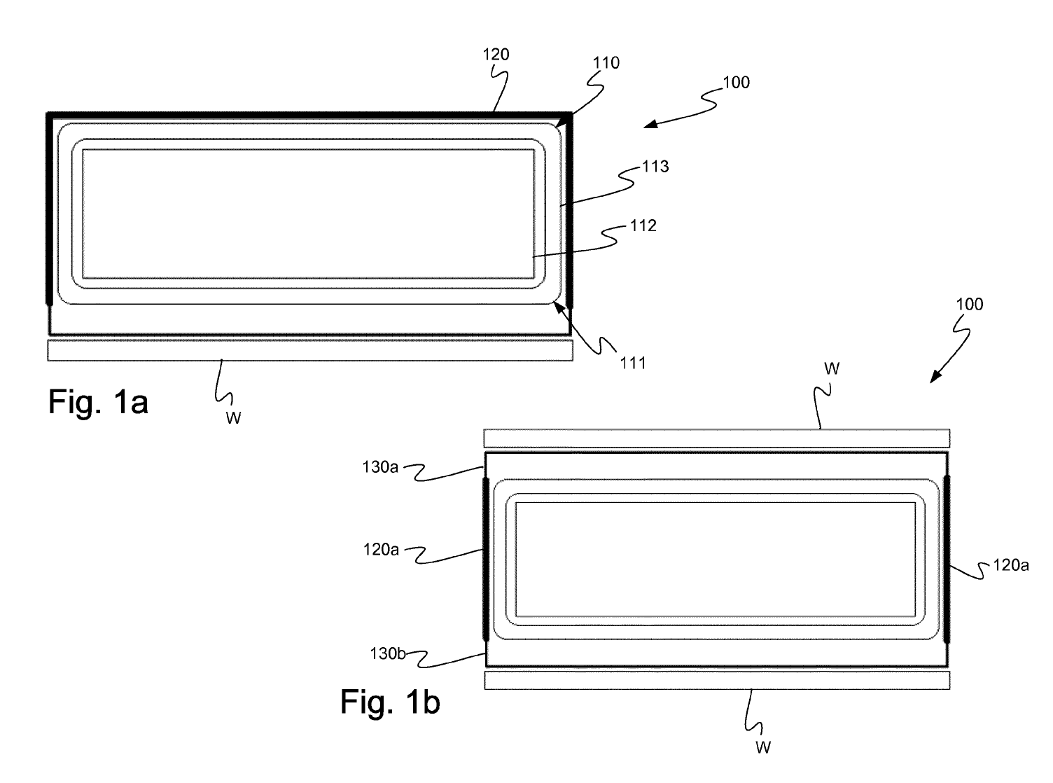

With reference to FIGS. 1a and 1b a heating apparatus 100 is provided, having at least one coil system 110 with at least one coil unit 111 connected to a power source (not shown), the coil unit 111 being arranged to create a magnetic field. The apparatus further having an electric current conductor 120 which is arranged at least partly around the coil unit 111, and an element 130, from now on called electrical return conductor or tool portion, which is configured to be heated and which is connected to the electric current conductor 120 in such a way that the electric current conductor 120 and the return conductor 130 form a closed conduit. The magnetic field of the coil unit 111 is arranged to induce a voltage in the electric current conductor 120 and the return conductor 130, the induced voltage creating an electric current in the closed conduit. The return conductor 130 is configured to be heated by the electric current. The coil unit 110 includes a coil core 112, preferably made of a soft magnetic material, and a winding 113 which is arranged around the core 112, where the coil unit 111 together with the power source creates the magnetic field. In this case the coil system 110 only consist of one coil unit 111 but in other embodiments, which will be described later, the coil system may consist of several coil units. The drive of the coil/coils 111 is made by a suitable power source, preferably an electronic frequency converter. Even an applied direct current may be used in order to affect the heating pattern if the return conductor 130, also called heating portion or return current conductor, is made of a soft magnetic material, this by locally saturate the material magnetically which changes the skin depth or penetration depth and therewith the current paths and the loss of the high frequent currents.

The electric current conductor 120 is partly arranged around the coil unit 111 and made of a material with good electrical conducting properties, e.g. copper, aluminum or any other suitable conductor material, as a driving system in order to induce the current through the return conductor 130, consisting of a material with a significantly higher resistivity than the return conductor, e.g. stainless steel, titanium, steel, carbon fiber or any other suitable material. The heating is therefor conducted entirely or mainly by resistive losses in the return conductor 130. The electric current conductor 120 is connected to the return conductor, (also called the heating part) with a purpose to guide the current without causing losses. A purpose of the coil unit 111 is to induce current in the electric current conductor 120 which then is guided through the return conductor 130.

Close to the return conductor 130 a workpiece W is arranged which is heated by the heat from the return conductor 130 in a controlled way. In FIG. 1b an alternative construction is shown where there are two workpieces W arranged on opposite sides of each other. This also means that the construction of the heating apparatus 100 is somewhat different since it has two return conductors 130a, 130b and two electric current conductors 120a, 120b.

The invention comprises hence an induction heater or inductor construction including a coil arrangement, possibly magnetic core material and a workpiece and electric return conductor or driver. In this case the element or return conductor 130 is a tool element configured to heat the adjacent workpiece W during the heating process. The apparatus 100 may heat the desired surface/body without it being arranged in the active work area.

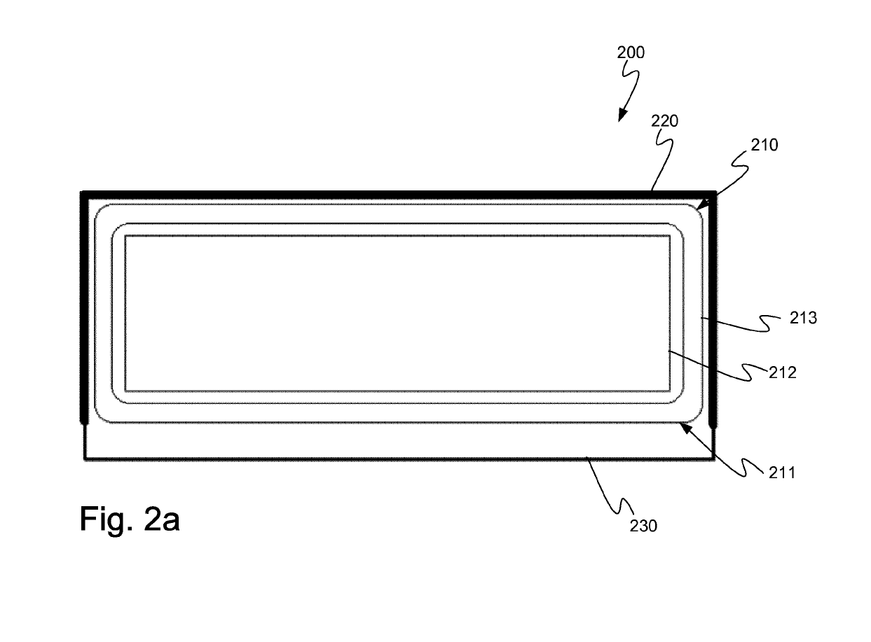

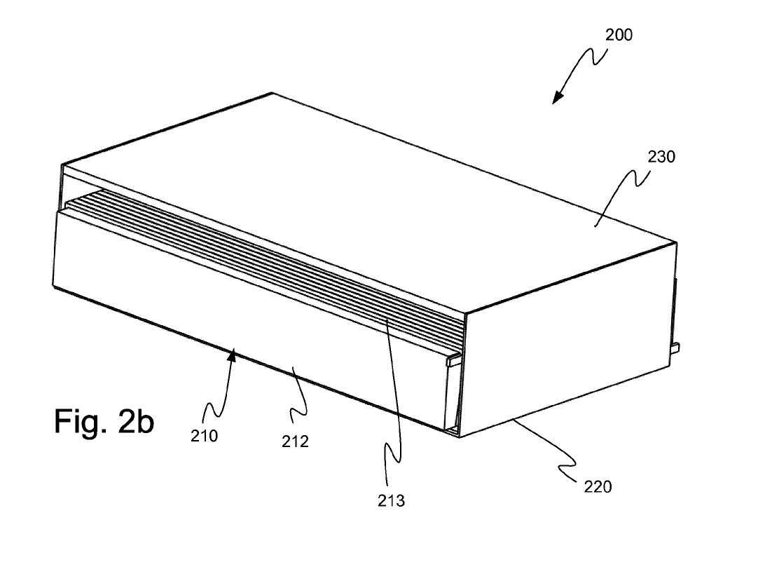

The apparatus 100 comprises a so called heating portion 130, which also may be referred to as a workpiece, depending on the configuration, which means the part of the conduit which shall receive a certain temperature and to which energy is about to be controlled. This surface may be a part of a tool in a process, e.g. for plastic molding, but may also be a part of an object to be heated and manufactured and after that be separated from the arrangement, see the following embodiment and FIGS. 2a and 2b. The heating portion 130 is, in its simplest geometrical shape a sheet, which is the most common way of showing it in the figures.

FIG. 1 illustrates the fundamental principle which provides desired heating results as the effect of an induction heating and the effect of a resistive heating is added together in a proper mix creating a uniform and controlled heating result and process. By adding more coils a more detailed controllability of the temperature is achieved. The text in the paragraph “3-coil inductor implementation” below shows the problem with only resistive heating, by which the controllability disappears and where over heating of the edges and corners appears at the same time, which is a challenge.

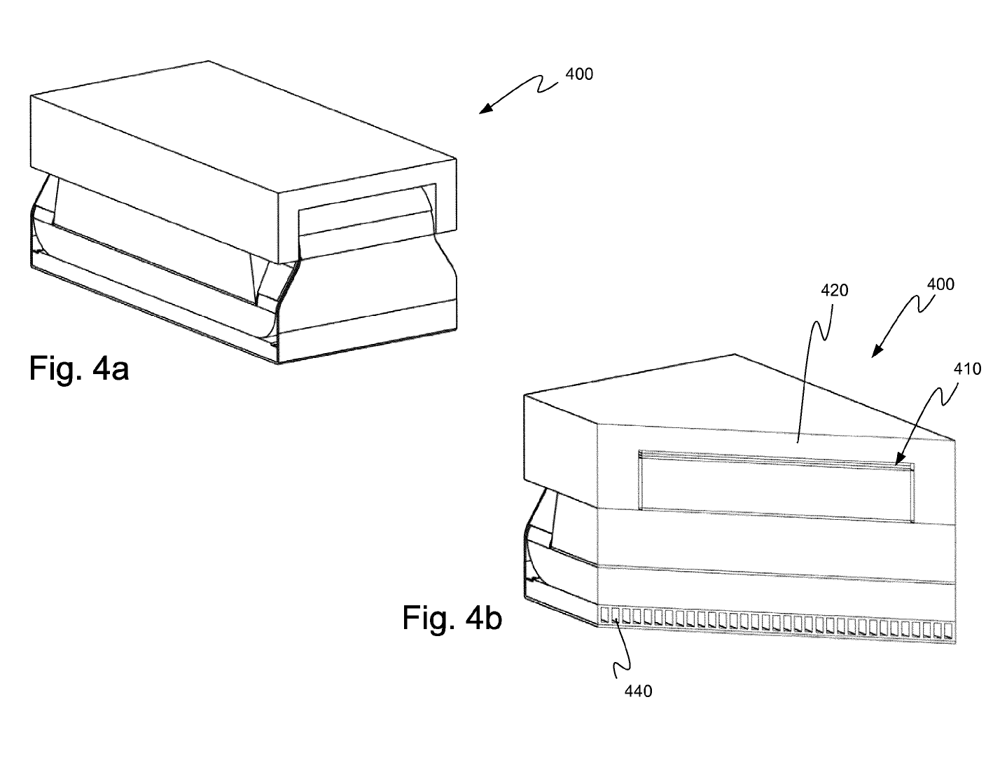

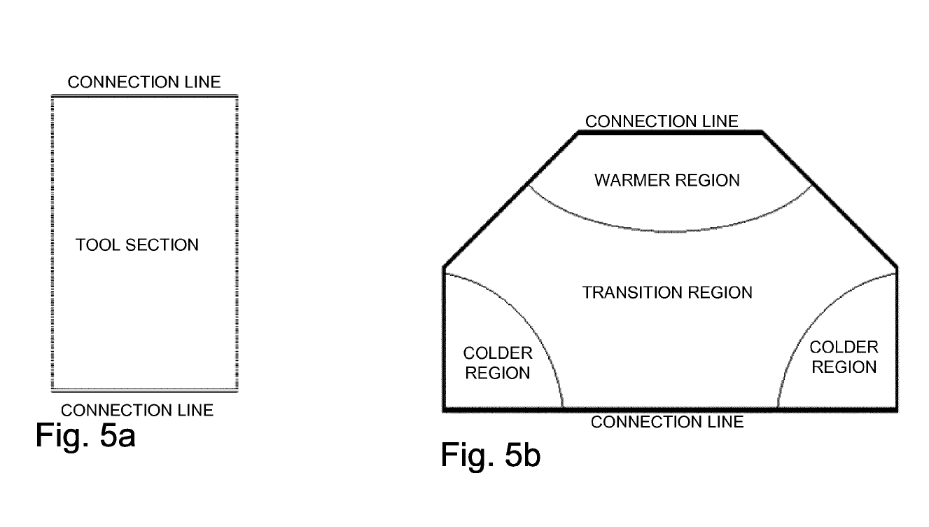

The flow conductor material is arranged within the coil unit 111, where the construction type is often named “longitudinal field” in order to focus the magnetic field and thus increase the efficiency. The flow conductor material is, with marginal benefit, able to surround the electric current conductor 120, see FIGS. 4a and 4b, or may with a reduced efficiency be left out.

If the electric current conduct 120 acts as the driving system a substantially larger distance between the coil unit 111 and the return conductor 130 may be allowed with a maintained efficiency than traditional induction heating. By making space just adjacent to the return conductor 130 (or the tool surface) it is possible to integrate an active cooler (not shown) in order to quickly be able cool the tool, e.g. when changing tools or thermal cycling. The space may also be used to thermally insulate the coil unit from the heated surface, which is an important feature at high tool temperatures, especially together with temperature sensitive material combinations such as Litz wire coils. Another example of an element that may be integrated in the space is micro mechanical actuators, piezo crystals for geometry control or vibration assisted functionality. In order to combine the inductive and the resistive contribution in a suitable way without advanced control then a proper thick sheet of a suitable conductor material, e.g. copper or aluminum be arranged in the space, which slightly dampers the magnetic field that affects the heating portion. In Table 1, to the right a 0.3 mm thick aluminum sheet has been used for this purpose with negligible losses.

With reference to FIGS. 2a and 2b an alternative heating apparatus 200 is provided having a coil system 210 like the one described above, an electrical current conductor 220 and a return current conductor 230. This embodiment differs from the above in that the return conductor 230 is a detachable element configured to be removed from the apparatus after a heating process, i.e. there is no workpiece arranged adjacent to the return conductor to be heated but instead the return conductor or the element is the workpiece.

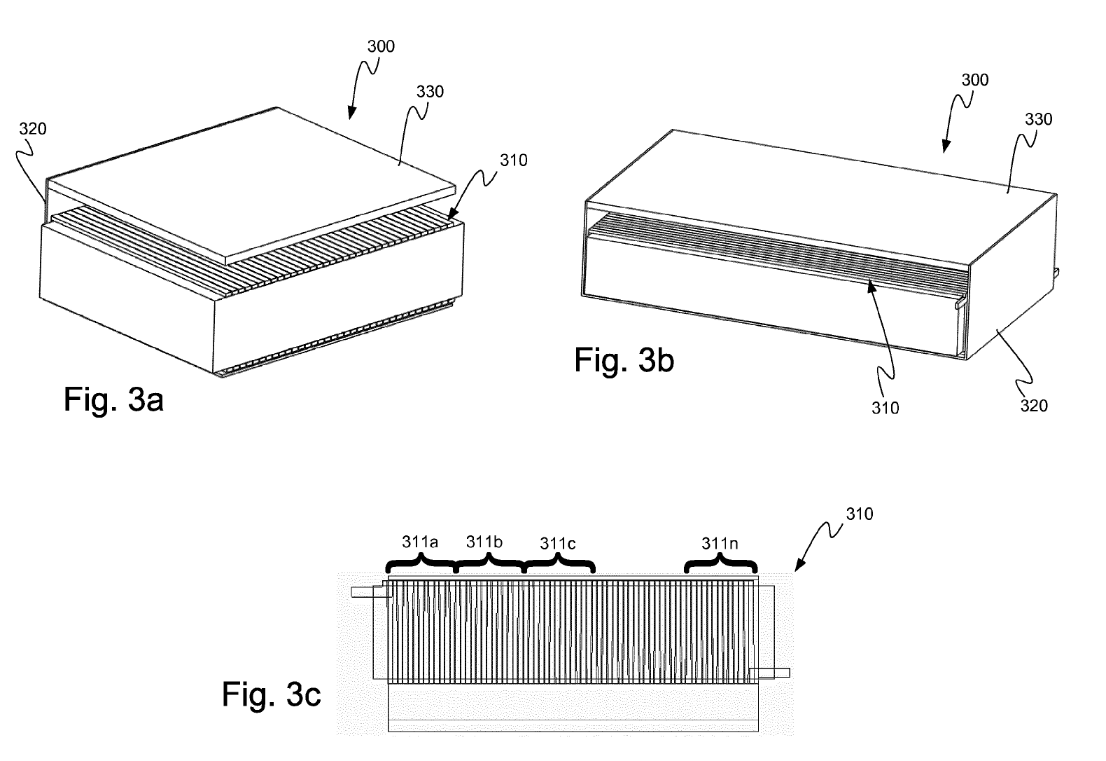

With reference to FIGS. 3a-c yet another heating apparatus 300 is provided. The main difference between this embodiment and the two previously described embodiments is that the coil system 310 consists of several coil units 311a-311n each with an individual drive in order to be able to control the temperature over the return conductor 330 independent of the power transit (the load). The coil system 310 may consist of any number of coil units 311a-311n but here five parallel coil units 311a-311n are shown. Even though the coil units 311a-311n are arranged parallel to each other they may in other embodiments be arranged in a different way.

FIGS. 4a and 4b show a construction with entirely enclosing electric current conductors 420, or flow conductors, varying cross section of the coil system 410 and a tubular or ribbed cooler 440. The coil units 411 may also be supplemented with an active cooling in the shape of an integrated tube or coolant channels for air and gas.

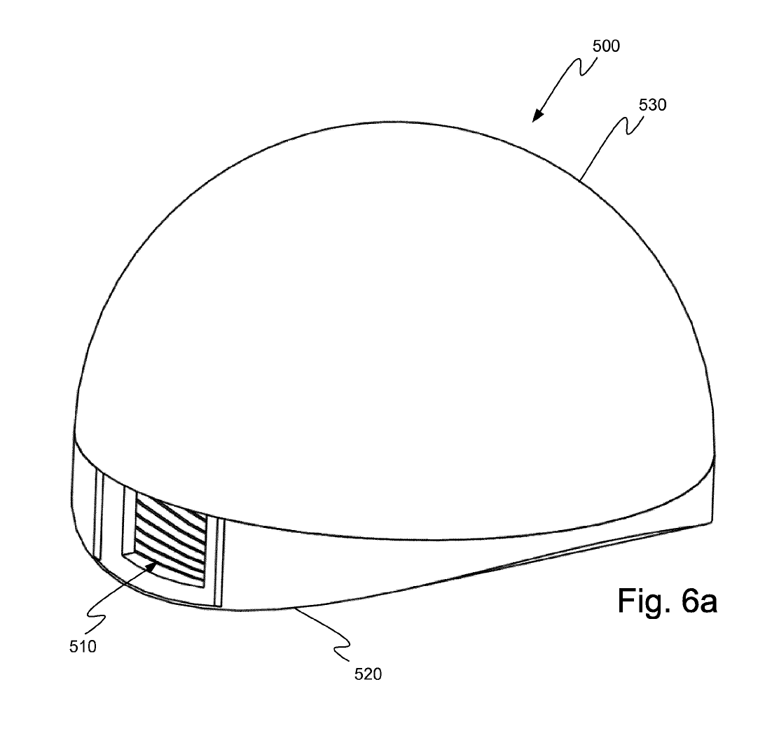

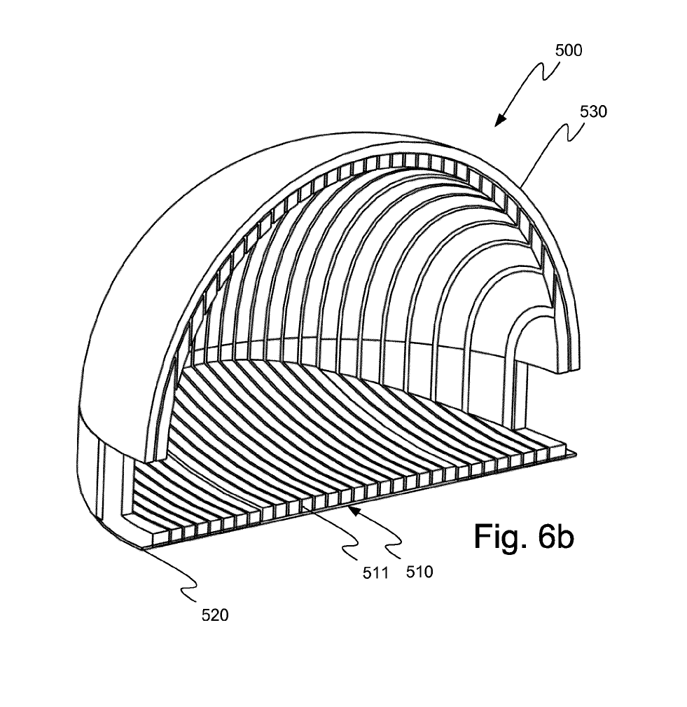

Yet another configuration of the invention is shown in FIGS. 6a and 6b where the fundamental principle to heat a double curved surface evenly is illustrated. The tool surface or the electric return conductor 530, in the shape of a semi-sphere is engaged with an electric current conductor 520 made by copper. An arrangement of coil units 511 distributes the effect evenly over the surface. The coil system 510 may also be configured for a relative movement (e.g. rotation) with respect or the tool surface 530 and the electric current conductor 520.

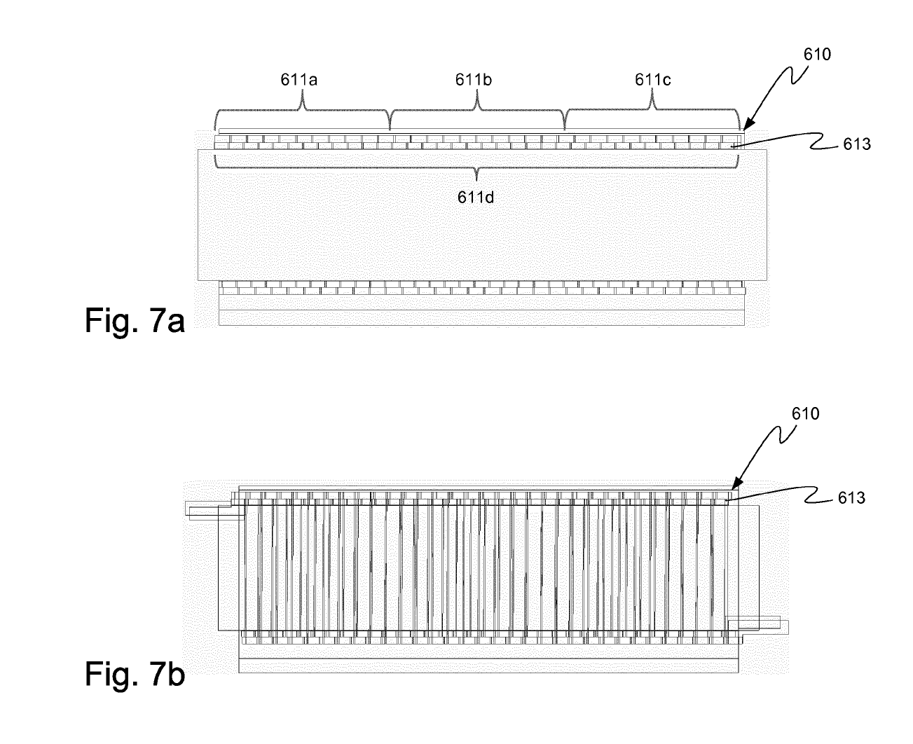

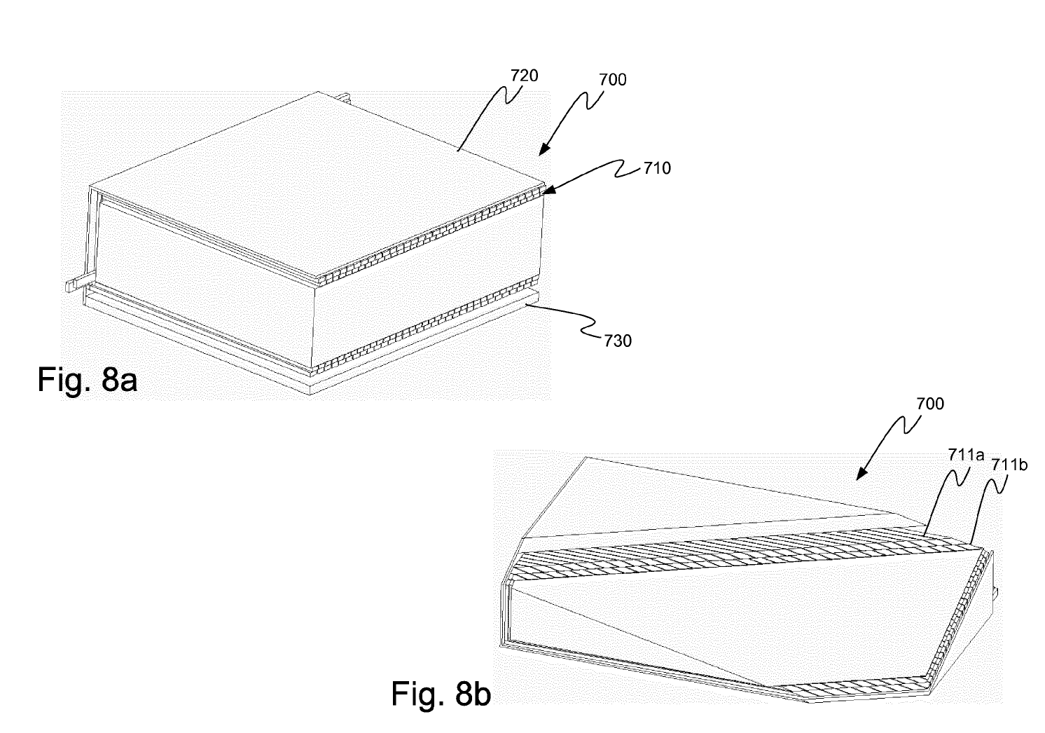

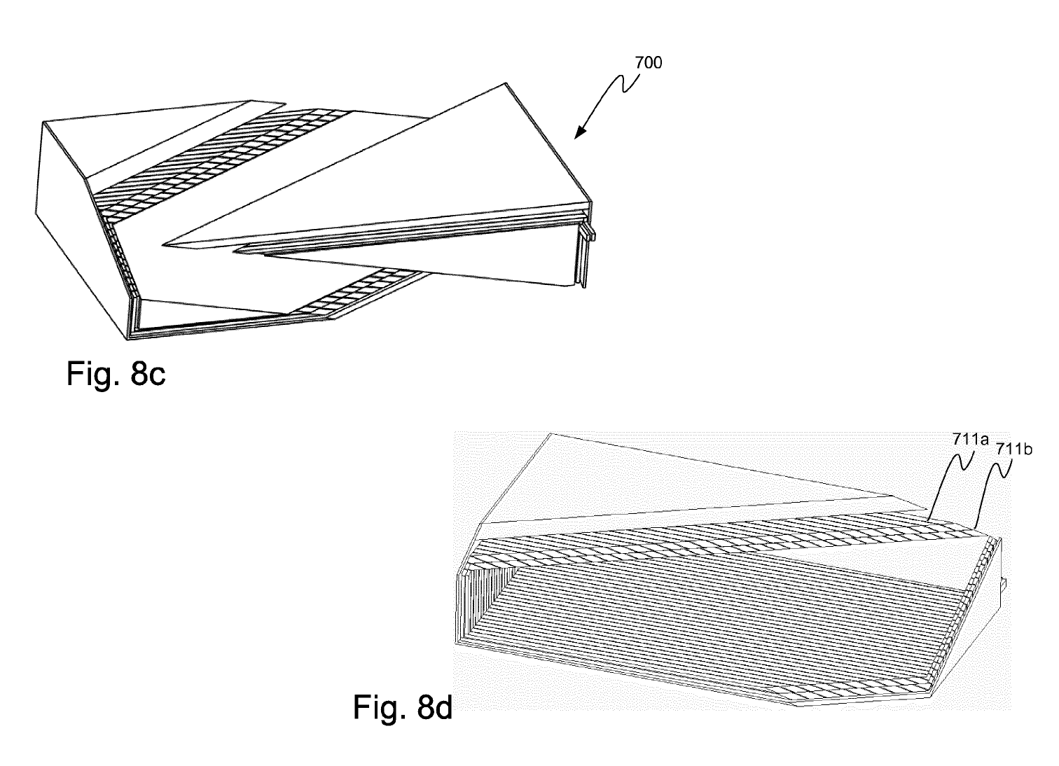

FIGS. 7a and 7b shows another construction of the coil system 610, where windings 613 are arranged on top of each other and where the different layers may be one or several different windings, all separately driven. This construction may for example be used in the following embodiment, see FIGS. 8a-8d.

FIGS. 8a-8d is a double layer heater, or a heater with several layers, where the outer coil unit 711a may provide the system with the largest amount of energy and the inner coil units 711b may be used to control the temperature of the relative surface. I.e. the most significant heating is conducted from a coil unit 711a which covers the entire surface and where the other coil units 711b are used to control the evenness or the heat pattern. The best inductor construction for a given application is a balance between what is reasonably to manufacture and what is easy to drive with a given power electronic control.

The electric current conductor may consist of parallel wires, stripes or similar, preferably interlaced with coiling in order to obtain maximum connection. The different conductors are then connected at the heating plate. The current conductor 720 may also be provided with cooling channels or surface enlargements in the shape of e.g. flanges depending on the application.

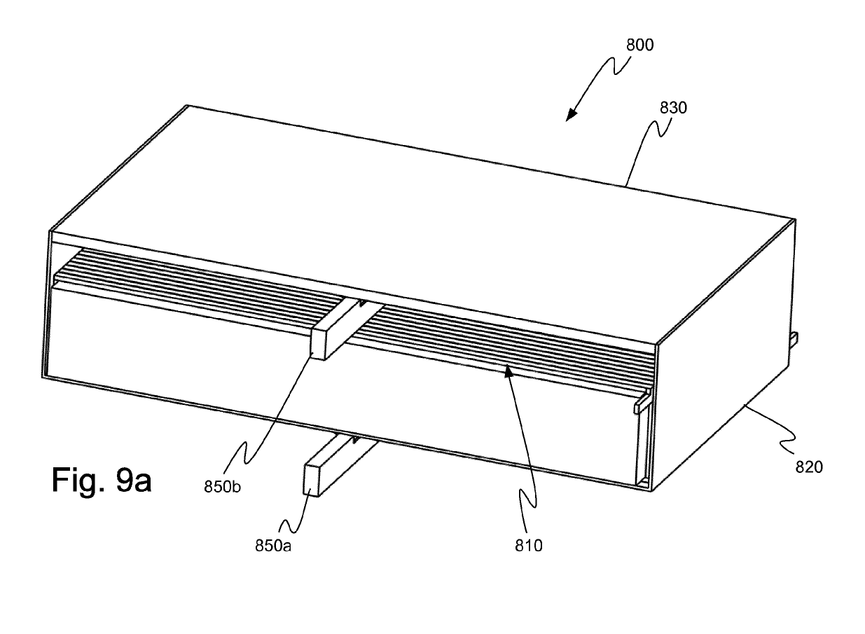

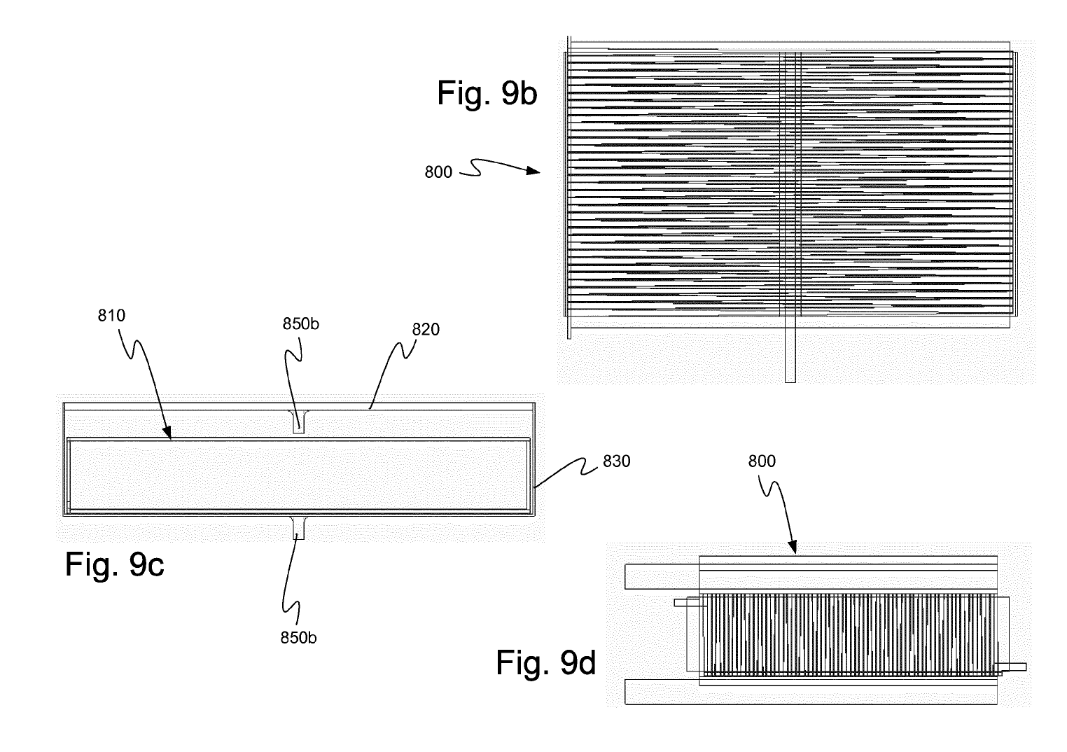

FIGS. 9a-9d show yet another alternative of a construction where the resistive heating, i.e. the connection units 850a, 850b, may take place parallel to controllable induction heating.

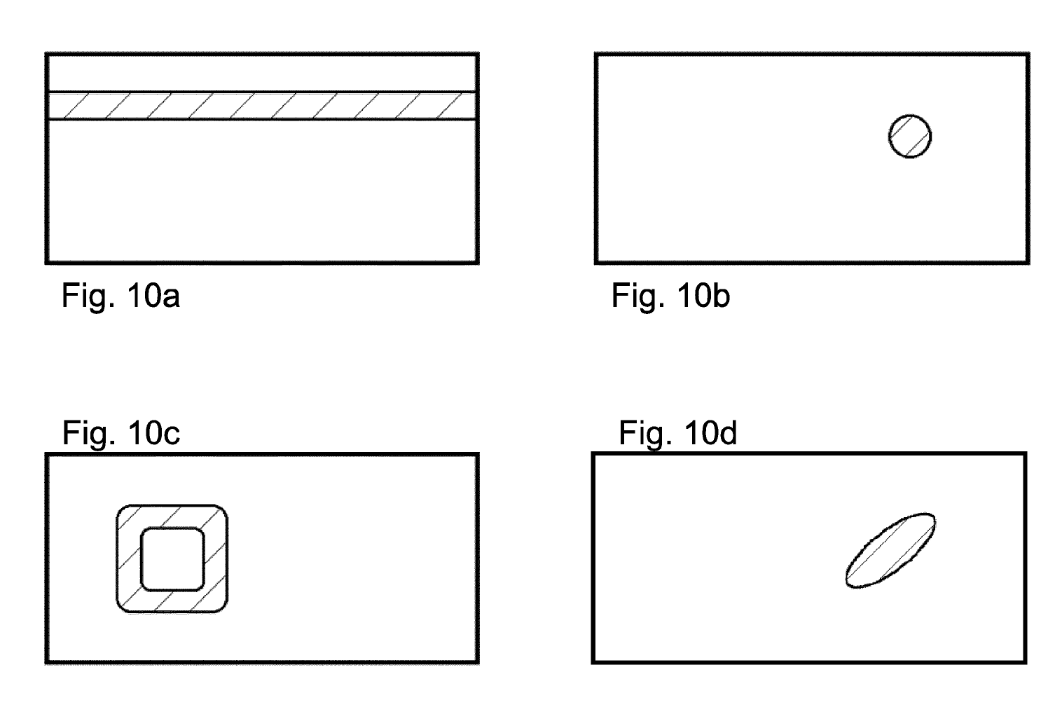

The heat pattern may be controlled by varying the amplitude and phase shift between the currents in the different coils. To minimize the affect that the coils have on each other suitable coils may be connected in series or anti-series, alternatively parallel or anti-parallel. To maximize the controllability the coils are controlled entirely separate of each other, coils from different (equivalent) inductors however be connected to each other to reduce the transformer capacity between each other. The currents are preferably independent between the coils but interference between the magnetic fields may provide an increased controllability even if sequential drive of the coils also gives a good result. If there are several coils they may be arranged above or underneath each other, interweaved or arbitrary intersected. What is unique for the invention is that by controlling the skin depth the magnetic vector field, by combining currents with different amplitudes, frequency and phase angle, it is possible to not only heat the entire workpiece but also to supply effect along lines or points (pixels) which makes and unbeatable controllability possible. FIGS. 10a-10d shows example of possible heating patterns, which may be combined in numberless ways.

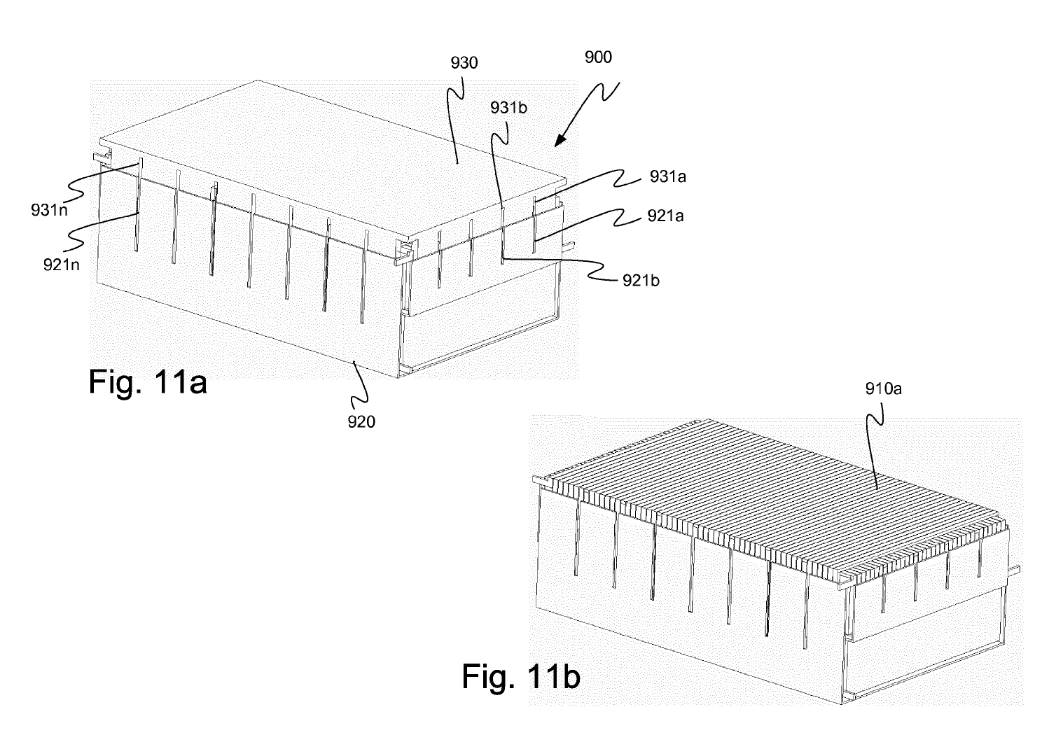

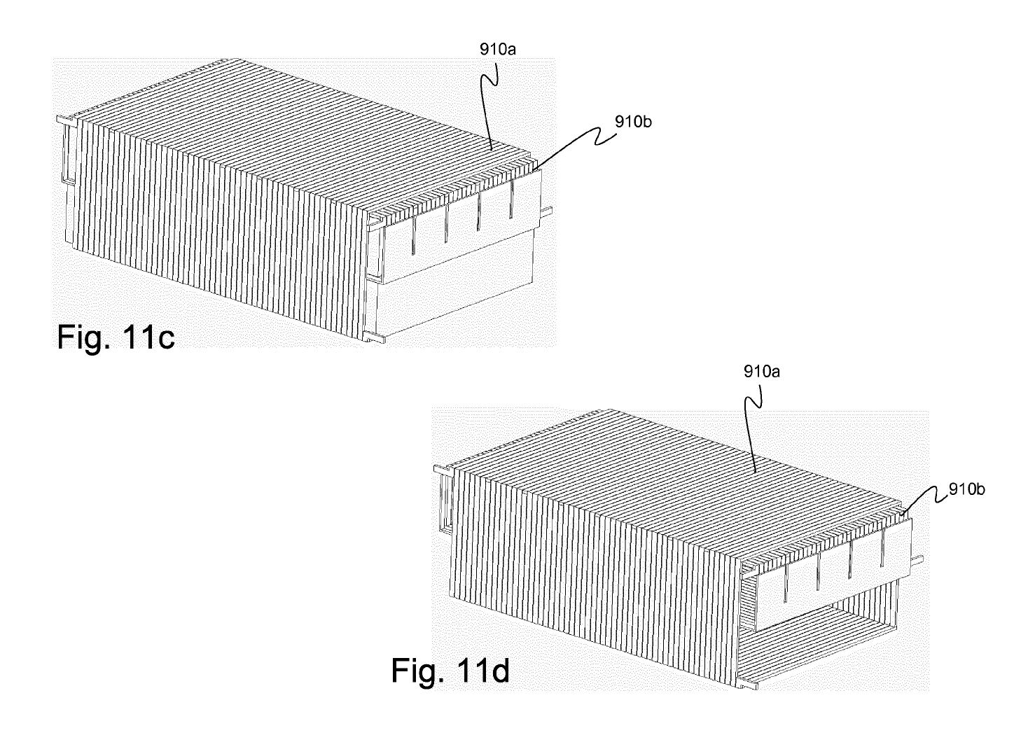

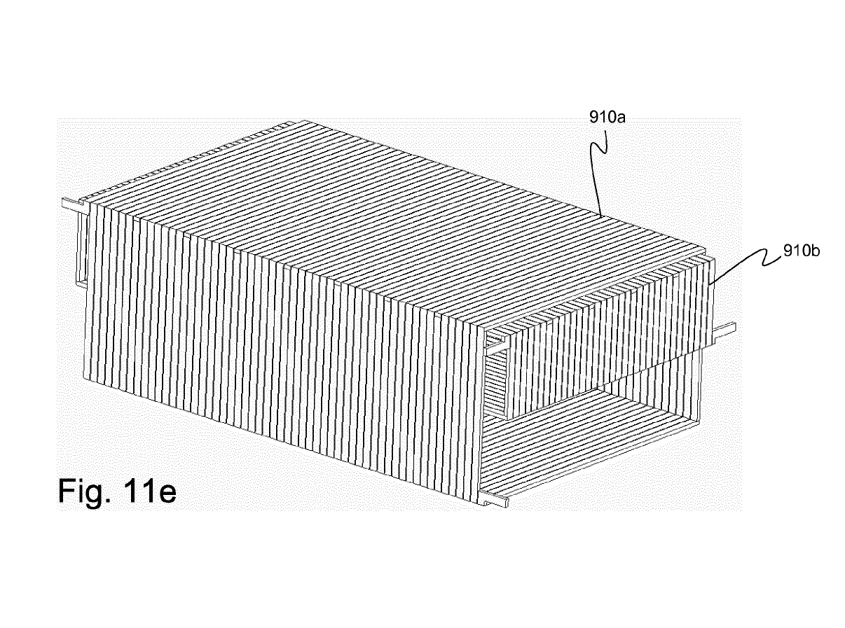

The figure series in FIGS. 11a-11e show an inductor solution for controlling the heat in two dimensions. The apparatus in this embodiment further comprises a second coil system 910b arranged adjacent and at least partly around the first coil system 910a. Also, the current conductor 920 and/or the element 930 (or return conductor) comprises at least one slot 921a-n, 931a-n which is arranged to guide the current/currents in the current conductor 920 and/or the element 930.

A split return conductor, see FIGS. 11a-11e, may be necessary for some conditions in order to avoid that currents run in the return conductor instead of the workpiece, it applies especially during control in two dimensions but also for curved surfaces as in FIGS. 6a and 6b.

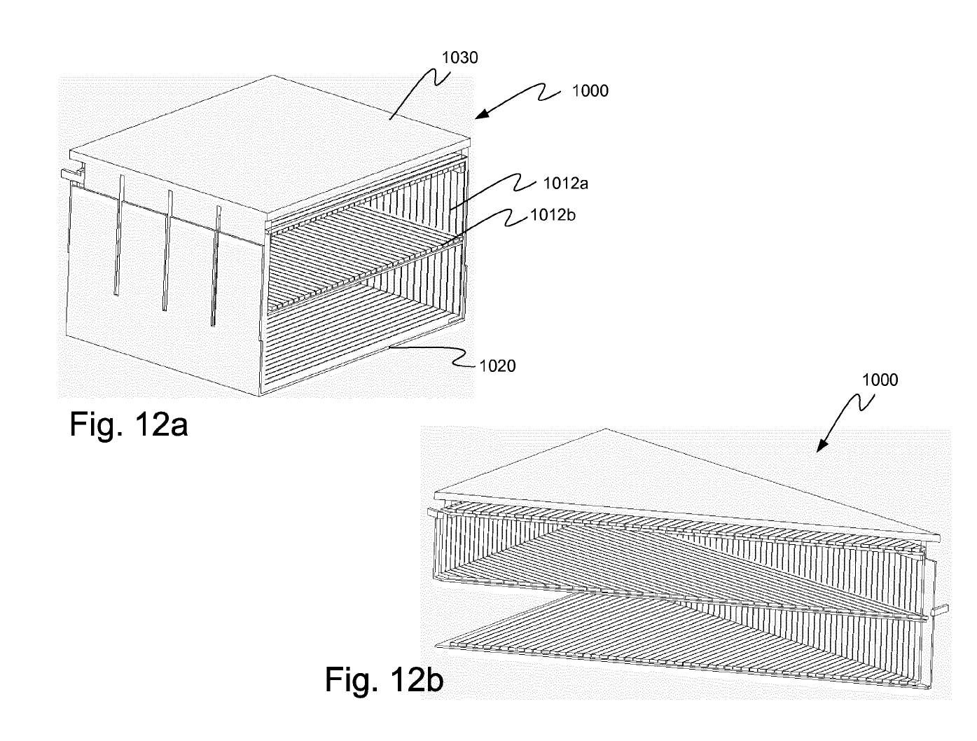

FIGS. 12a and 12b show an alternative embodiment of the previous slotted apparatus 900, but with a different interior arrangement of coil units 1011a, 1011b.

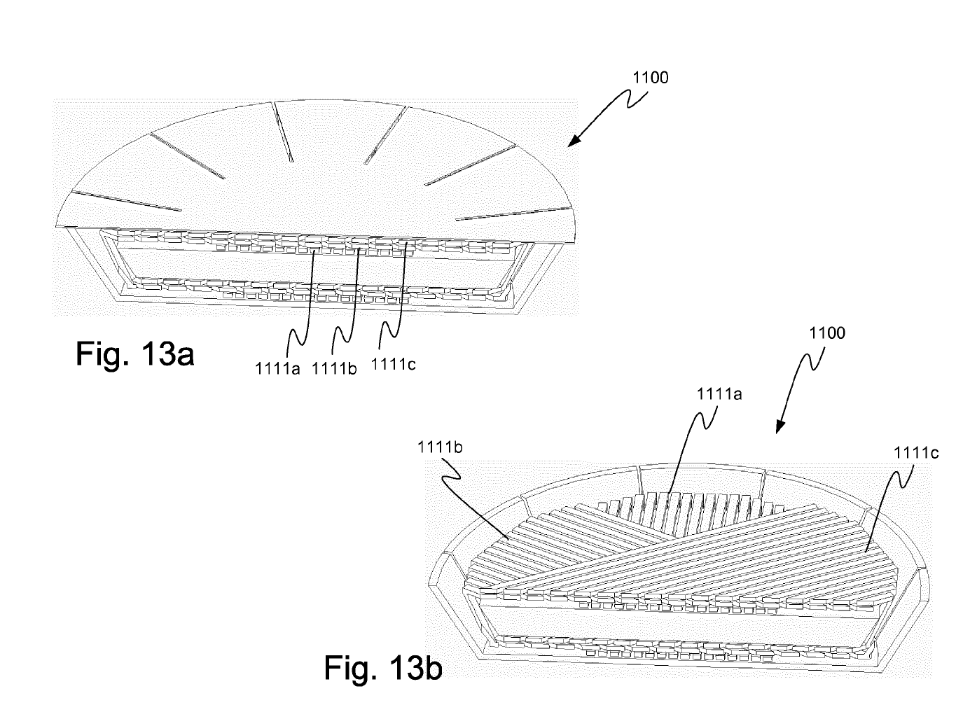

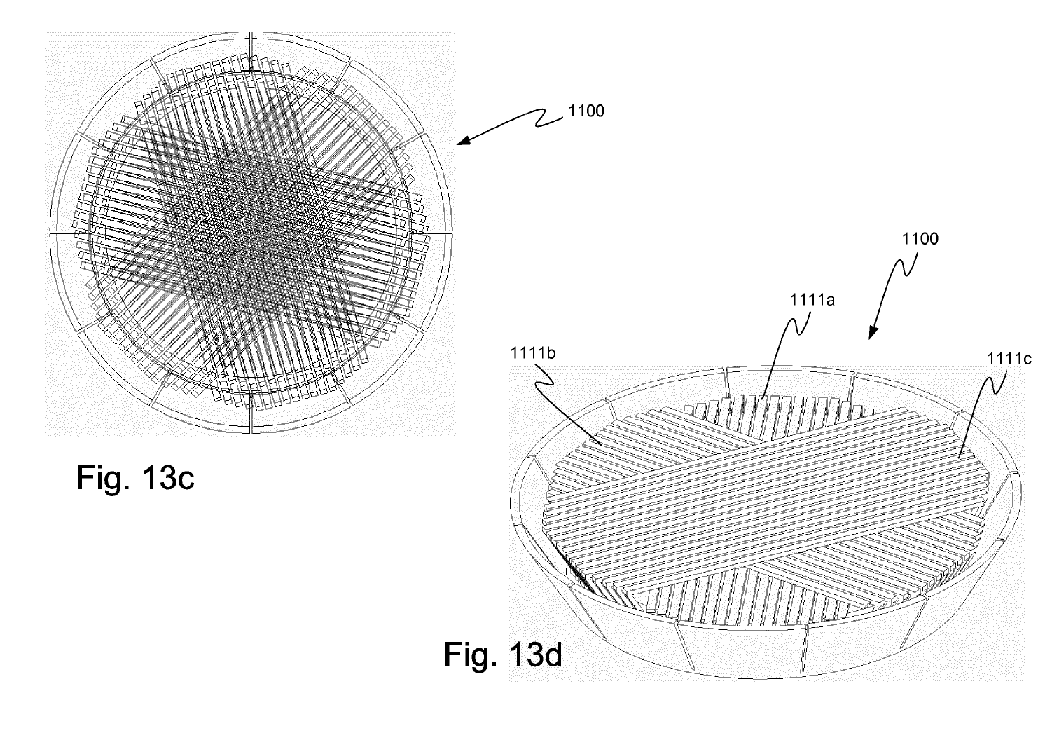

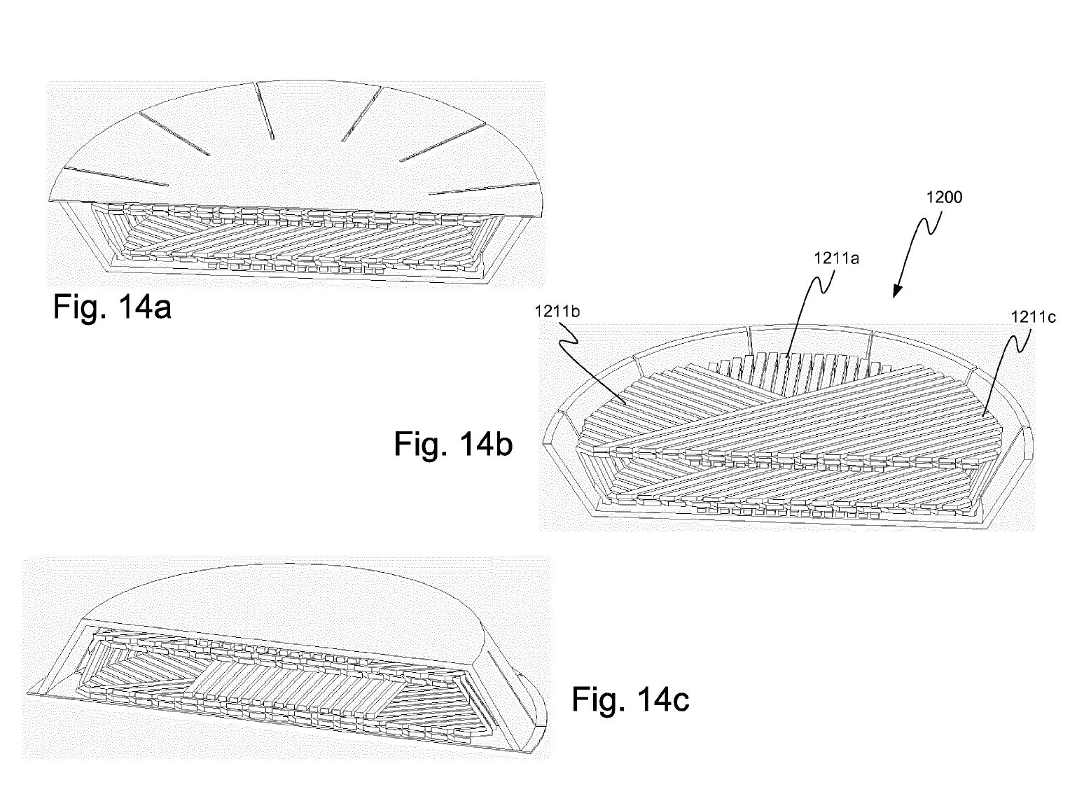

FIGS. 13a-d and 14a-c show yet further embodiments where an inductor (or heater) apparatus 1100, 1200 have a coil arrangement with coil units 1111a-c, 1211a-c arranged in three different directions all with a common return conductor instead of one in each direction.

The connection between the electric current conductor and the return conductor may be accomplished by welding, soldering, screw joint reinforcement, mechanical joint or any other suitable method. Electrical insulation between the coil units, the coil unit and the core and the coil unit and the return conductor or the electric current conductor is important to avoid short circuit or electrical breakdown. Examples of an insulation material are varnish, epoxy, nomex, glass fibre, textile, fabric or any other insulating material. A construction without insulating material, i.e. with only air is also possible. The electric current conductor could be in one piece or split in one or several places for an easier manufacture/disassembly etc. It can be one or several electric current conductors in order to maximize the efficiency, the heating result or the complexity.

All described apparatus and embodiments thereof may be supplemented with active cooling between the coil unit/units and the return conductor to be able to cool the tool, e.g. at thermal cycling or a tool change in a machine. Several alternative cooling principles may be used, but where the most suitable probably is conduction through flowing gas or liquid, phase transfer from a solid or liquid state to fluid or gas by means of the Seebeck effect/thermoelectric effect through a Peltier element. By implementing a heating/cooling concept significant improvements in the evenness of temperature/controllability could quickly be achieved.

All solutions have assumed that there is a closed circuit according to the description, but some of them may also be able to work without an electric current conductor by arranging soft magnetic cores with a high permeability which encloses the coils in a similar way and which also may be a good alternative within a closed circuit. The core material compresses the electro magnetic flow and focuses the heating around its regions while the return currents only contribute with a very small heating effect. The core material is also important when magnetizing with a DC-current as it creates regions with reduced heating and may, depending on the number of coils and its geometry and placement, adopt more or less complex forms. The inactive parts of the coil may advantageously be covered in a good conductor material such as copper, aluminum or similar, to reduce the current inductance and therewith the magnetizing current, and, but not necessary, the surrounding magnetic field. The cover material may be provided with coolant channels or surface enlarging elements such as flanges.

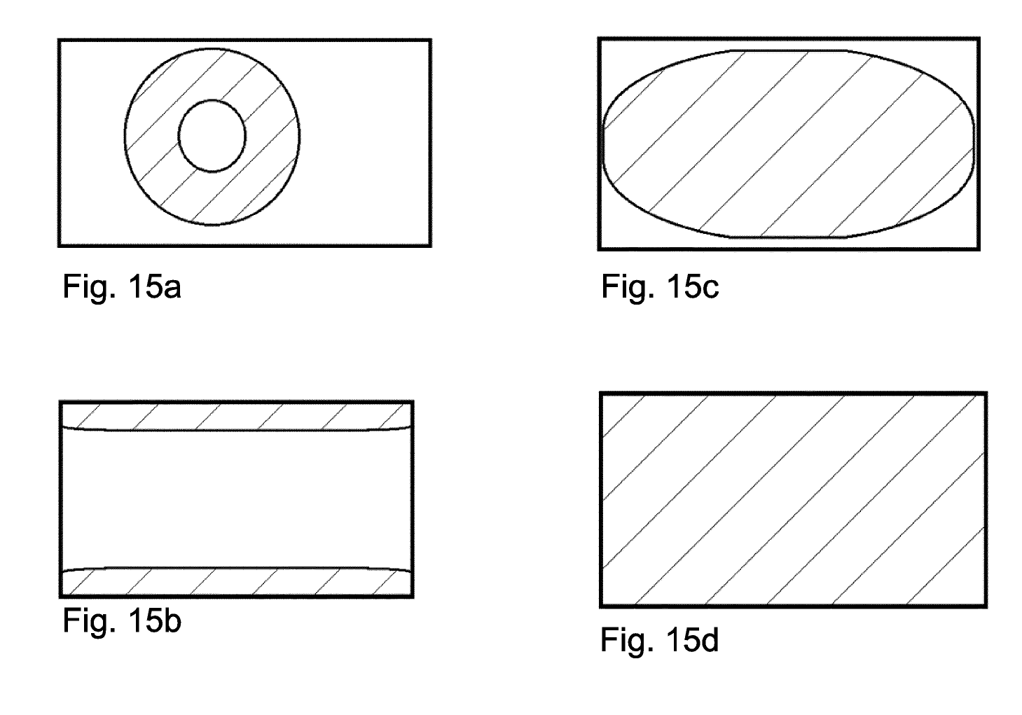

FIGS. 15a-c are possible heating patterns achieved by existing heating methods, and FIG. 15d is a uniform heating pattern that can be obtained by combining the result of FIG. 15b and FIG. 15c, which can be obtained by the heating apparatus according to the present invention.
The uniqueness of the invention may be summarized in the following 7 matters.
Uniform heat: Known techniques solves the problem be using very large tool bodies where the heat conduction after a longer period of time achieves an even heat profile. Induction heating is an energy effective heating technique for many processes within engineering processes and the food processing industry. Uniform heat is however difficult to achieve with existing induction technique since heating only occurs immediately under the electrical conductor. This problem is solved by the present invention since the electrical losses are distributed evenly or according to what is desired in a tool plate thanks to the controllability of the many coils. Varying thickness of the object, thermal radiation and different geometrical cases of load etc. makes it very difficult to achieve a uniform heat profile only by traditional resistive heating where large currents in combination with contact resistances may be a problem.
Uniform heating of surfaces with uneven load: By first heating resistively and supplement with inductive zone heating a uniform heat profile may be achieved even if the surface is cooled inhomogeneously or if it has different thick cross sections.
Uniform heating of asymmetrical or double curved surfaces: By inductively generate the current which creates the resistive losses in the tool surface the current conducting areas and the loss pattern may be varied in different ways which creates conditions for a uniform or controlled heating of complex curved surfaces.
Cycle time: The active tool plate can be made very thin which means that the heated volume (the tools) of material is very low. This means that another problem may be solved, namely to minimize the heating time and the possible cooling time. Except from being able to shorten the cycle times for a certain process, e.g. pressing of laminate, set-up time and waiting time before a tool change and maintenance work may be reduced substantially. A heated tool based on known technique, e.g. with electrical immersion heater arranged in a drilled hole, and may have a heating time and cooling time of several hours depending on the volume of the tool material. The present invention has a heating time and cooling time of typically one minute.
Integrated cooling: The construction of the invention allows a larger air gap between the coil and the tool plate which is a gap that may be used for thermal insulation but also for integrating a cooler unit, e.g. based on streaming water. This means that the tool plate may be thermally cycled very efficiently.
Integration in the tool: The construction of the invention, where the active tool plate also form the outer border of the measurements of the heating unit, makes it very well suited to be integrated in different types of tools for pressing etc., so called intool heating. Reinforcements of the structure allow the unit to handle among other things the pressure in many processes.
Controllable heating: By controlling the skin depth and the magnetic vector field, by combining currents with different amplitude, frequency, and phase angle, it is possible not just to heat the entire workpiece but to also provide effect along open or closed lines or points (pixels) which enables an unbeatable control unit. Important features to have a high geometric controllability are the use of multiple coils and especially multiple coils in different directions in combination with advanced control of the current in each coil.
Advantages compared to traditional resistive heating are among other things:
Favorable operation point (lower current and higher voltage over the workpiece) due to a small skin depth and therewith higher equivalent resistance in the workpiece (compared to 50 Hz). Requires high permeable workpiece thicker than 0.1 mm or non-permeable workpiece thicker than 2 mm. The improvement implies reduced losses and fewer problems with the contact resistance.
The heat is primarily on the surfaces instead of in the entire workpiece (assuming the thickness according to above).
The controllability of the temperature across the surface despite uneven geometric load. Significant uniform temperature pattern compared to resistive heating with high frequency (kHz field).
Advantageous compared to traditional induction heating are among other things:
Uniform heating across an entire, plane exposed surface without movable details.
Allows substantially larger air gap between the coil and the workpiece with a maintained efficiency. The gap makes room for e.g. a cooler unit, thermal insulation or built-in actuator functions.
Possibility to compensate uneven geometric load.

Three Coil Inductor Implementation

The implementation or the experiments refers to verify the hypothesis that by placing a LF-inductor, with several separate controlled coils within a closed, welded construction made of a copper casing and a workpiece made of steel, the temperature over the surface may be controlled in a dimension, unlike if the inductor is placed outside the closed circuit.

The inductor consists of 5+14+9 windings of solid, insulated copper wire, 2×4.5 mm, wrapped in one layer close to each other around an insulated flow conductor core of SM²C according. The coil in the center is called coil and the two on the sides are connected in series and are called coils, each one connected to an independent electronic frequency converter and checked to have approximately the same resonance frequency. The distance between the coil and the copper casing is 0.5-1 mm and the air gap between the coil and the workpiece within the conduit is approximately 9 mm. The distance between the copper casing and the workpiece is approximately 40 mm and the magnetic field from the current in one part is assumed not to significantly affect the current in the other, which otherwise would lead to an increased heating in the center (axially)

The results clearly show that the hypothesis is correct! When the inductor is placed within the conduit it is possible to axially control the heat pattern, i.e. perpendicular to the direction of the current. Is the inductor instead placed outside the conduit then the possibilities to control disappear entirely.

The results indicate that the combination of 5+9 windings of the same current loop is not optimal in order to achieve uniform heating but the configuration is one way that with one and the same inductor is able to test different effects. An inappropriate placement of the joint between copper and steel, in combination with an extensively thick copper casing allows the workpiece to cool significantly and unnecessary much along the edges. A more well dimensioned construction with optimized coils, for best result a two-dimensional solution in order to be able to control the effect in further directions, the problem would be solved. Even a well made and return connected control is required to achieve the desired result, as well as a control of the cross-connection between the coils, but the experiments still shows the possibilities without finding any limitations, but a substantial double curved workpiece, e.g. a semi sphere, means however new challenges. The heat spread is apparent due to a relatively slow process in order to have the time to manually control the two coils and at the same time take a photograph without rising to put something on fire.

Finally, although the inventive concept has been described above with reference to specific embodiments, it is not intended to be limited to the specific form set forth herein. Rather, the invention is limited only by the accompanying claims and, other embodiments than the specific above are equally possible within the scope of these appended claims.

1. An apparatus for controllable heating, comprising at least one coil system with at least one coil unit connected to a power source, the coil unit being arranged to create a magnetic field, the apparatus further comprising at least one electric current conductor ON) which is arranged at least partly around said coil unit, and at least one element which is configured to be heated and which is connected to the electric current conductor in such a way that the electric current conductor and the element form a closed conduit, wherein the magnetic field of the coil unit is arranged to induce a voltage in the electric current conductor and the element, the induced voltage creating an electric current in the closed conduit, wherein the element is configured to be heated by the electric current.

2. The apparatus according to claim 1, wherein the at least one coil unit comprises a core made of a soft magnetic material, and an at least one electric winding.

3. The apparatus according to claim 1, wherein the power source is a frequency converter.

4. The apparatus according to claim 1, wherein the electric current conductor ON) is made of a material chosen from a group of copper, aluminum or any other suitable conductor material.

5. The apparatus according to claim 1, wherein the element is made of a material with a higher electrical resistance, e.g. stainless steel, titanium, carbon fiber composite or any other suitable material, compared to the material of the electric current conductor.

6. The apparatus according to claim 1, wherein at least a part of the element is spaced a apart from the coil unit.

7. The apparatus according to claim 1, further comprising a cooling device arranged in the space between the element and the coil unit.

8. The apparatus according to claim 1, further comprising a cooling capability integrated in the element.

9. The apparatus according to claim 1, further comprising a thermal insulation device arranged in the space between the element and the coil unit.

10. The apparatus according to claim 1, further comprising a vibration device arranged in the space between the element and the coil unit.

11. The apparatus according to claim 1, further comprising an electromagnetic field attenuating component, e.g. a foil or sheet of copper or aluminum, arranged in the space between the element and the coil unit.

12. The apparatus according to claim 1, wherein the element is a detachable element configured to be removed from the apparatus after a heating process.

13. The apparatus according to claim 1, wherein the element is a tool element, configured to heat an adjacent workpiece during a heating process.

14. The apparatus according to claim 1, wherein the coil system comprises several coil units, wherein the current in each coil unit is individually controlled and/or synchronized with each other.

15. The apparatus according to claim 14, wherein each coil unit is at least partly overlapping an adjacent coil unit.

16. The apparatus according to claim 1, further comprising a second coil system arranged adjacent and at least partly around the first coil system.

17. The apparatus according to claim 1, wherein the electric current conductor and/or the element comprises at least one slot which is arranged to guide the current/currents in the electric current conductor and/or the element.

18. The apparatus according to claim 1, wherein the at least one coil unit has a varying cross section geometry of its wrapping and/or core along the closed conduit.

19. The apparatus according to claim 1, wherein at least two individual electric connectors are used to partially heat the element from an external supply of AC or DC current.

20. The apparatus according to claim 1, wherein the coil system is electrically insulated from the closed conduit.

21. Use of an apparatus according to claim 1 during a heating process.

22. Method of manufacturing a heating apparatus comprising the steps:
providing at least one coil system comprising at least one coil unit connected to a power source,
arranging at least one electric current conductor around at least a part of the coil unit, and
connecting at least one element configured to be heated to the electric current conductor ( )such that the electric current conductor and the element form a closed circuit.

23. Method of transferring heat to a workpiece (W) comprising the steps:
providing an apparatus according to claim 1,
creating a magnetic field in the coil unit
inducing a voltage in the electric current conductor creating an electric current which heat up the element, and
providing a workpiece adjacent to the element, wherein the element transfers the heat to the workpiece.
